(19) United States
(12) Patent Application Publication
(10) Pub. No.: US 2008/0129263 A1
(43) Pub. Date: Jun. 5, 2008

(54) Mixed signal digital controller for switched mode power supplies

(75) Inventors: Sridhar Kotikalapoodi, Santa Clara, CA (US); James Zeng, Cupertino, CA (US); Farzan Roohparvar, Monte Sereno, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/633,542

(22) Filed: Dec. 5, 2006

(51) Int. Cl. G05F 1/10; G05F 1/00

(52) U.S. Cl. 323/283; 323/282

(57) ABSTRACT

A method and apparatus is disclosed for an internal control circuit that switches transistors rapidly on and off to stabilize the output voltage or current of a switch-mode power supply (SMPS). The internal control circuit uses analog and digital signals to regulate the output voltage of the switch-mode power supply. The internal control circuit adjusts the output voltage using pulse width modulation. The duty cycle of the pulse is based upon the comparison of the output voltage and a reference level.

### FIELD OF THE INVENTION

The present invention relates generally to switch-mode power supplies and specifically to regulation of an output voltage of switch-mode power supply using a mixed signal digital controller.

### BACKGROUND

A switch-mode power supply (SMPS) is an electronic power supply unit that incorporates a switching regulator. A switching regulator is an internal control circuit that rapidly switches transistors on and off to stabilize the output voltage.

FIG. 1 illustrates a block diagram of a conventional analog controller for a switched mode power supply. The switched mode power supply 100 is implemented as a closed loop having an input voltage V_{IN} and an output voltage V_{OUT}. The switched mode power supply 100 regulates the input voltage V_{IN} to produce the output voltage V_{OUT}. More specifically, the switched mode power supply 100 produces the output voltage V_{OUT} by stepping down the input voltage V_{IN}. The switched mode power supply 100 may be used to regulate the output voltage V_{OUT} when the input voltage V_{IN} fluctuates.

The switched mode power supply 100 utilizes an analog controller 102 to regulate the input voltage V_{IN}. In an exemplary embodiment, the analog controller 102 may sense or monitor the output voltage V_{OUT} through a resistive voltage divider 108 formed by a resistor 110 and a resistor 112. More specifically, connecting the resistor 110 in series with the output voltage V_{OUT} and shunting the resistor 112 to a ground forms the resistive voltage divider 108. The analog controller 102 monitors a scaled output voltage 142 located in between the resistor 110 and the resistor 112.

The analog controller 102 then compares the scaled output voltage 142 to a reference voltage V_{REF} using an error amplifier 104. In an exemplary embodiment, the analog controller 102 may compare the output voltage V_{OUT} instead of scaled output voltage 142 to a reference voltage V_{REF} using the error amplifier 104. The error amplifier 104 includes an operational amplifier 120 to amplify a difference between the scaled output voltage 142 and the reference voltage V_{REF}. Although the error amplifier 104 is implemented using an operational amplifier, those skilled in the arts will understand that any suitable device may be used. As shown in FIG. 1, a “−” denotes the inverting connection of the operational amplifier 120 and a “+” denotes a non-inverting connection of the operational amplifier 120. The scaled output voltage 142 couples to the inverting connection of the operational amplifier 120 while the reference voltage V_{REF} couples to the non-inverting connection of the operational amplifier 120. A capacitor 114 connects between the inverting connection of the operational amplifier 120 and an output of the operational amplifier 120. A resistor 116 connects in series with a capacitor 118. By connecting between the inverting connection of the operational amplifier 120 and the output of the operational amplifier 120, the series connected resistor 116 and capacitor 118 forms a parallel connection with the capacitor 114. The capacitor 114, the capacitor 118, and the resistor 116 form the analog compensation components of the error amplifier 104.

During operation, the analog controller 102 adjusts an output of the error amplifier 104 depending on the difference between the scaled output and the reference voltage V_{REF}. For example, when the output voltage V_{OUT} is less than a required value, the scaled output voltage 142 is less than the reference voltage V_{REF}. As a result, the output of the error amplifier 104 will increase. On the other hand, when the output voltage V_{OUT} is greater than the required value, the scaled output voltage 142 is greater than the reference voltage V_{REF}. As a result, the output of the error amplifier 104 will decrease.

The analog controller 102 next converts the output of the error amplifier 104 to a pulse width modulated signal using a pulse width modulator (PWM) 106. The pulse width modulator includes a comparator 126 and a flip-flop 128. A comparator is a device that compares two voltages or currents and switches its output to indicate the larger of the two voltages or currents. The comparator 126 compares the output of the error amplifier 104 with a saw tooth or ramp function, denoted as 122 in FIG. 1. When the ramp function is lesser than the output of the error amplifier 104, the comparator 126 output is low and the Q output of the flip flop 128 stays high. Likewise, when the ramp function is greater than the output of the error amplifier 104, the comparator output goes high and resets the flip flop 128 output to low. Thus, the output of the comparator 126 forms a pulse whereby the relationship between the output of the error amplifier 104 and the ramp function determines the width of the pulse. In other words, the duty cycle of the output of the comparator 126 terminates when the ramp function crosses the output of the error amplifier 104. The flip-flop 128 then latches the output of the comparator 126 according to a clock pulse 124. In an exemplary embodiment, flip-flop 128 is implemented as a SR latch or SR-flip-flop, those skilled in the arts will recognize that any suitable device may be used. In this exemplary embodiment, the flip-flop 128 has a set and a reset input, denoted as S and R in FIG. 1, and two complementary outputs, denoted as Q and Q′. Normally, in storage mode, the S and the R input of flip-flop 128 are both low maintaining the Q and Q′ outputs in a constant state, with Q the complement of Q′. If the S (set) is pulsed high while the R (reset) is held low, then the Q output is forced high, and stays high when the S returns low. On the other hand, if the R is pulsed high while the S is held low, then the Q output is forced low, and stays low when the R returns low. The flip-flop 128 uses a clock pulse 124 for the set input and the output of the output of the comparator 126 for the reset input. As a result, the Q output of the flip-flop 128 represents a pulse width modulated (PWM) version of the clock pulse 124.

A gate drive logic (GDL) module 130 drives a switch module 132 according to the Q output of the flip-flop 128. The switch module 132 may be implemented using metal oxide semiconductor field effect transistors (MOSFET) fabricated according to a complementary metal oxide semiconductor (CMOS) process. The switch module includes a switch 138 and a switch 140. The switch 138 and the switch 140 operate in a complementary manner. In other words, when the Q output of the flip-flop 128 is high, GDL module 130 closes the switch 138 while opening the switch 140. Opening of the switch 138 and closing of the switch 140 charges a capacitor 136 by allowing current to flow from the input voltage V_{IN} through the switch 138 and an inductor 134. By charging the capacitor 136, the analog controller 102 increases the output voltage V_{OUT}. Likewise, when the Q output of the flip-flop 128 is low, GDL module 130 opens the switch 138 while closing the switch 140. Closing of the switch 140 and opening of the switch 138, discharges the capacitor 136 by allowing current to flow from the capacitor 136 through the switch 140 and the inductor 134 to ground. By discharging the capacitor 136, the analog controller 102 decreases the output voltage V_{OUT}.

As seen from FIG. 1, the analog controller 102 may be implemented using resistors 110, 112, and, 116 and capacitors 114, 118, and 136 as compensation components. However, since the compensation components have fixed values, they cannot be dynamically adjusted depending on system conditions such as system load to provide an example. In addition, implementation of non-linear control functions may be difficult when using resistors and capacitors as the compensation components. Finally, component aging as well as process and temperature variation of the compensation components may make the system less reliable.

FIG. 2A illustrates a block diagram of a conventional digital controller for a switched mode power supply. The switched mode power supply 200 is implemented as a closed loop having an input voltage V_{IN} and an output voltage V_{OUT}. The switched mode power supply 200 regulates the input voltage V_{IN} to produce the output voltage V_{OUT}. More specifically, the switched mode power supply 200 produces the output voltage V_{OUT} by stepping down the input voltage V_{IN}. The switched mode power supply 200 may be used to regulate the output voltage V_{OUT} for a fluctuating input voltage V_{IN}.

The switched mode power supply 200 utilizes a digital controller 202 to regulate the input voltage V_{IN}. The digital controller 202 compares the output voltage V_{OUT} to a reference voltage V_{REF} using an analog to digital converter (ADC) 204. The ADC 204 digitizes a differential error signal between the output voltage V_{OUT} and the reference voltage V_{REF} into a digital word, denoted as Dₑ.

A control law module 206 then computes a digital duty cycle, denoted as D_{C}, based on the differential error signal Dₑ. The control law module 206 represents a digital version of the compensation components of the error amplifier 104 as shown in FIG. 1. The control law module 206 implements a control function to regulate and stabilize the loop. In an exemplary embodiment, the control function implemented according to the well known proportional-integral-derivative (PID) control may be represented as:

D_{C}[k+1]=KₚDₑ[k]+K_{d}(Dₑ[k]−Dₑ[k−1])+KᵢDᵢ[k], (1)

where D_{C}[k] represents the duty-ratio at discrete time k, Dₑ[k] represents a digitized version of the differential error signal Dₑ, Dᵢ[k] represents a state of a digital integrator, given by Dᵢ[k+1]=Dᵢ[k]+Dₑ[k], Kₚ represents the proportional gain, K_{d} represents the derivative gain, and Kᵢ represents the integral gain. In another exemplary embodiment, the rounding of Kₚ, K_{d}, and Kᵢ to a corresponding power of two, allows the use of simple adders and binary shift registers to implement the control law module 206. In a further exemplary embodiment, the control law module 206 may also be implemented with look up tables or with dedicated digital signal processors (DSP) or microcontrollers if sophisticated computations are required. As a result of the dynamic control of Kₚ, K_{d}, and Kᵢ, these exemplary embodiments allow the use of digital controller 202 for various platforms.

A digital pulse width modulator (DPWM) 208 generates a pulse width modulated waveform based upon the differential error signal Dₑ. DPWM 208 is explained in further detail in FIG. 3 and FIG. 4. The switch module 132 uses an output of DPWM 208 to generate the output voltage V_{OUT} in a similar manner as described in FIG. 1.

As shown in FIG. 2A, the digital controller 202 utilizes the DPWM 208 to generate the pulse width modulated waveform used by switch module 132. However, implementation of the DPWM 208 poses several challenges. An output of the DPWM 208 requires a large number of bits both for sufficient accuracy and to avoid steady state oscillations known as limit cycles.

FIG. 2B illustrates a block diagram of a conventional digital pulse width modulator (DPWN) for a switched mode power supply. DPWM 240 is an exemplary embodiment of the DPWM 208 as shown in FIG. 2A. The DPWM 204 uses a counter based approach to generate a pulse width modulated waveform based upon the differential error signal Dₑ. Generation of the pulse width modulated waveform requires a large number of bits. For N-bit resolution, the counter clock needs to be 2^{N} times the switching frequency. For example, for a 10-bit resolution and a 1-MHz switching frequency, the counter clock needs to run at 1-GHz which results in significant power consumption.

FIG. 2C illustrates another block diagram of a conventional digital pulse width modulator for a switched mode power supply. DPWM 280 is an exemplary embodiment of the DPWM 208 as shown in FIG. 2A. The DPWM 280 use a tapped delay line approach to generate a pulse width modulated waveform based upon the differential error signal Dₑ. A pulse from a reference clock starts a cycle, and sets the PWM output high. The pulse propagates through the delay line and when it reaches the output selected by the multiplexer, the PWM output goes low. The total delay of the delay line is adjusted to be equal to the total switching clock period by a delay-locked loop. This approach, however, requires significant implementation area.

A hybrid counter-delay line DPWM module may been be implemented as a compromise solution. But this implementation still needs high frequency clock and large implementation area and needs a delay-locked loop. The DPWM may also be implemented with a delta-sigma modulator. Delta-sigma DPWM has low resolution PWM output and relies on the averaging effect of the output LC filter to increase the effective bit resolution. The dithering effect of the averaging produces undesirable low frequency ripple and the spectral content of the ripple is hard to predict. Non delta-sigma dithering techniques can be used to increase the effective bit resolution but these too suffer from the undesired low frequency ripple and spectral content.

What is needed is an internal control circuit for a switch-mode power supply for low power applications without sacrificing performance and significant die area penalties.

### BRIEF DESCRIPTION OF THE DRAWINGS/FIGURES

The present invention is described with reference to the accompanying drawings. In the drawings, like reference numbers indicate identical or functionally similar elements. Additionally, the left most digit(s) of a reference number identifies the drawing in which the reference number first appears.

FIG. 1 illustrates a block diagram of a conventional analog controller for a switched mode power supply.

FIG. 2A illustrates a block diagram of a conventional digital controller for a switched mode power supply.

FIG. 2B illustrates a block diagram of a conventional digital pulse width modulator for a switched mode power supply.

FIG. 2C illustrates another block diagram of a conventional digital pulse width modulator for a switched mode power supply.

FIG. 3 illustrates a block diagram of mixed signal digital controller according to an exemplary embodiment of the present invention.

FIG. 4 illustrates a block diagram of mixed signal pulse width modulator according to an exemplary embodiment of the present invention.

FIG. 5A illustrates a block diagram of digital to analog converter used in a mixed signal digital controller according to an exemplary embodiment of the present invention.

FIG. 5B illustrates another block diagram of digital to analog converter used in a mixed signal digital controller according to an exemplary embodiment of the present invention.

FIG. 5C illustrates a further block diagram of digital to analog converter used in a mixed signal digital controller according to an exemplary embodiment of the present invention.

FIG. 6 is a flowchart of exemplary operational steps of a mixed signal digital controller according to an aspect of the present invention.

The present invention will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

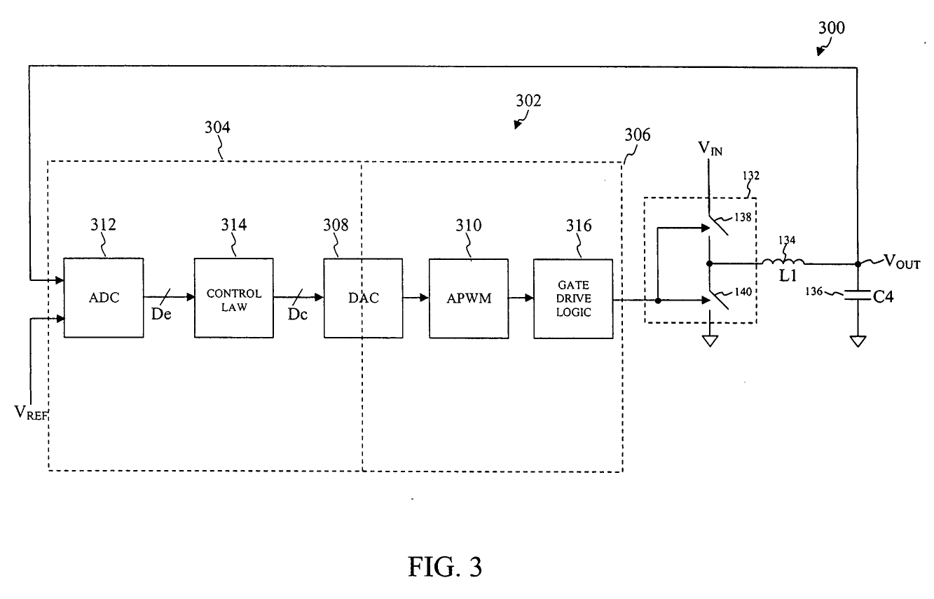

FIG. 3 illustrates a block diagram of mixed signal pulse width modulator according to an exemplary embodiment of the present invention. The switched mode power supply 300 is implemented as a closed loop having an input voltage V_{IN} and an output voltage V_{OUT}. The switched mode power supply 300 regulates the input voltage V_{IN} to produce the output voltage V_{OUT}. More specifically, the switched mode power supply 300 produces the output voltage V_{OUT} by stepping down the input voltage V_{IN}. The switched mode power supply 300 may be used to regulate the output voltage V_{OUT} for a fluctuating input voltage V_{IN}.

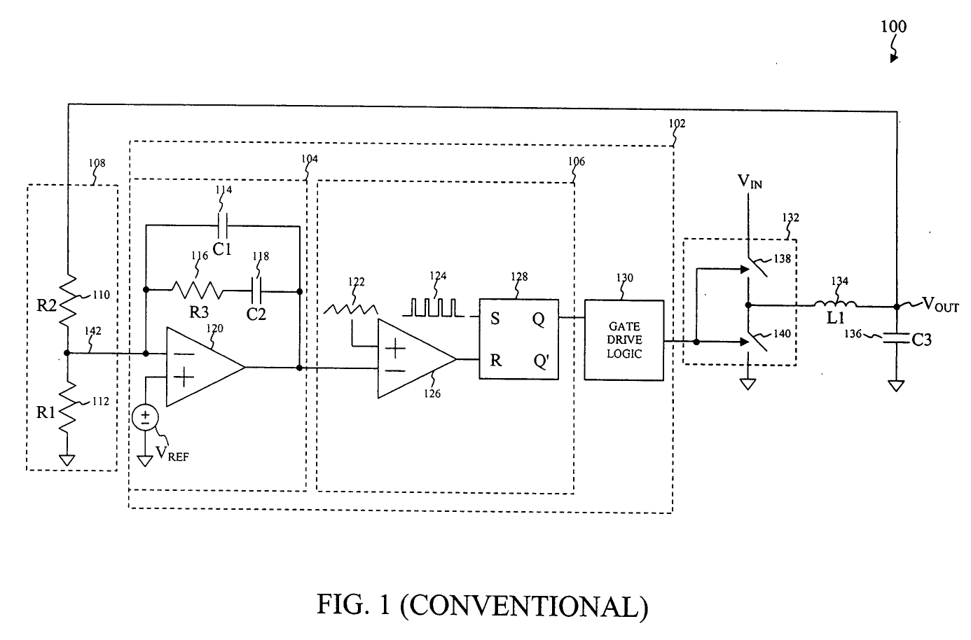

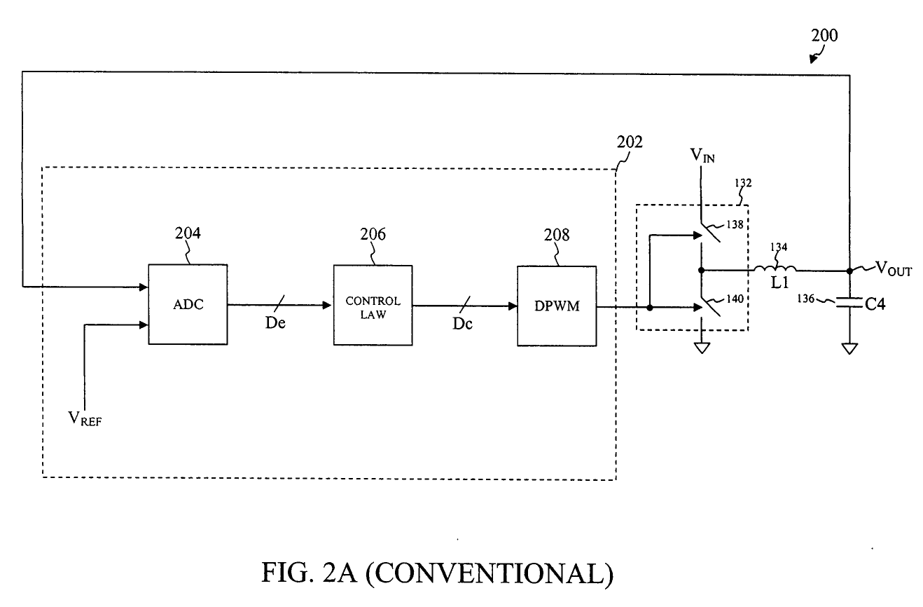

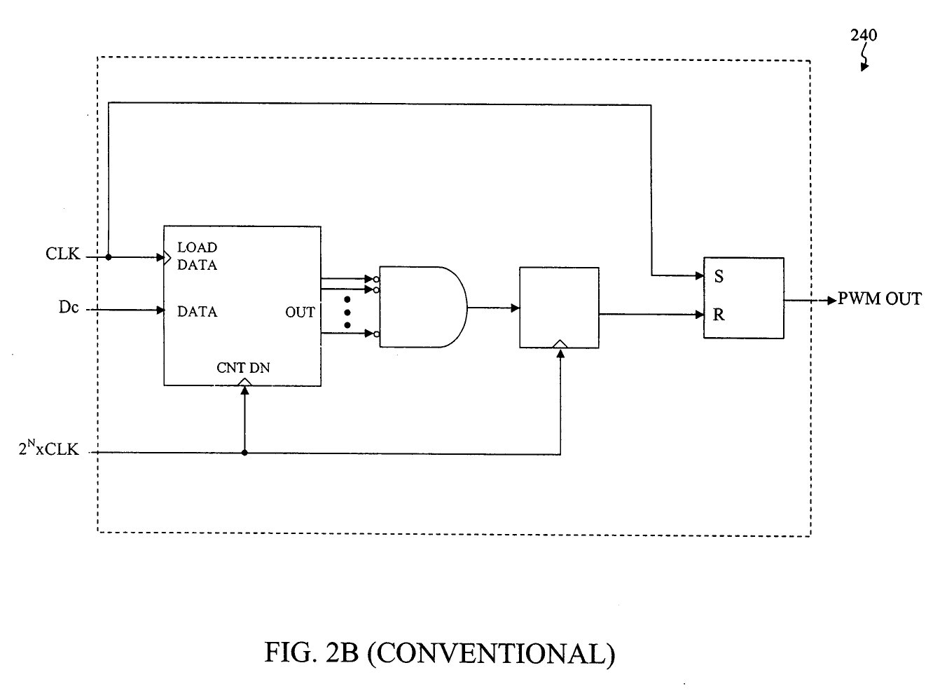

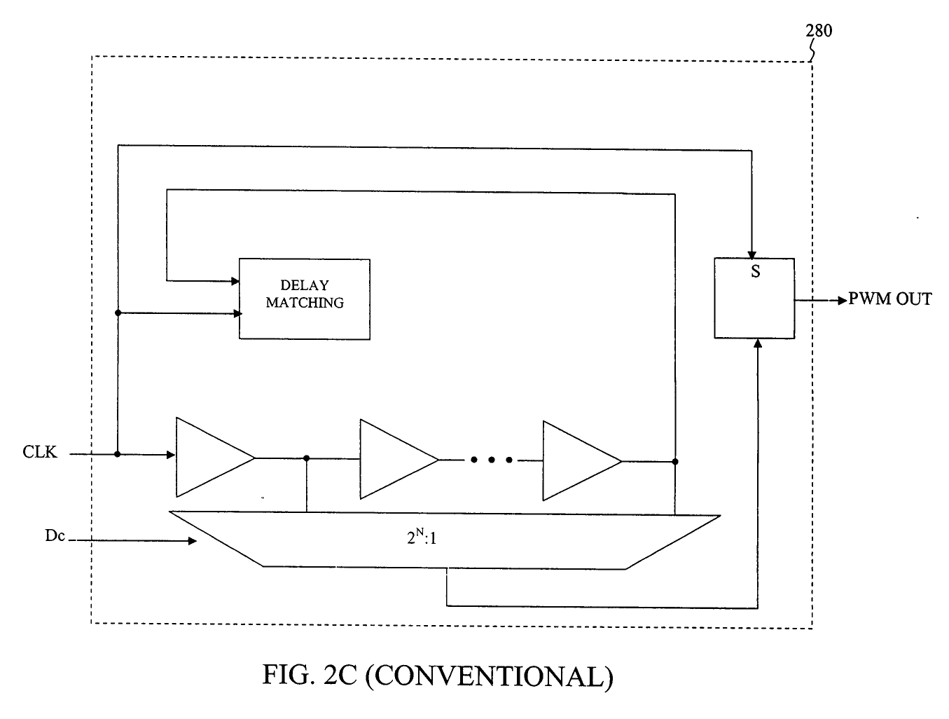

The switched mode power supply 300 utilizes a mixed signal digital controller 302 to regulate the input voltage V_{IN}. The mixed signal implementation offers several benefits compared to a pure analog, as shown in FIG. 1, or a pure digital solution, as shown in FIG. 2A. The mixed signal digital controller 302 does not need the analog compensation components as required by the analog controller 102. Similar to digital controller 202, the compensation coefficients of the mixed signal digital controller 302 may be changed dynamically and non-linear control can be easily implemented by the control law 314. In addition, switching clock frequency can be dynamically varied for efficiency and ripple spectrum optimization.

The mixed signal digital controller 302 compares the output voltage V_{OUT} to a reference voltage V_{REF} using the analog to digital converter (ADC) 312. The ADC 312 digitizes a differential error signal between the output voltage V_{OUT} and the reference voltage V_{REF} into a digital word, denoted as Dₑ.

The control law module 314 then computes a digital duty cycle, denoted as D_{C}, based on the differential error signal Dₑ. The control law module 314 represents a digital version of the compensation components of the error amplifier 104 as shown in FIG. 1. The control law module 314 implements a control function to regulate and stabilize the loop. In an exemplary embodiment, the control function implemented according to the well known proportional-integral-derivative (PID) control and may be represented as:

D_{C}[k+1]=KₚDₑ[k]+K_{d}(Dₑ[k]−Dₑ[k−1])+KᵢDᵢ[k], (2)

where D_{C}[k] represents the duty-ratio at discrete time k, Dₑ[k] represents a digitized version of the differential error signal Dₑ, Dᵢ[k] represents a state of a digital integrator, given by Dᵢ[k+1]=Dᵢ[k]+Dₑ[k], Kₚ represents the proportional gain, K_{d} represents the derivative gain, and Kᵢ represents the integral gain. In another exemplary embodiment, the rounding of Kₚ, K_{d}, and Kᵢ to a corresponding power of two, allows the use of simple adders and binary shift registers to implement the control law module 314. In a further exemplary embodiment, the control law module 314 may also be implemented with look up tables or with dedicated digital signal processors (DSP) or microcontrollers if sophisticated computations are required. As a result of the dynamic control of Kₚ, K_{d}, and Kᵢ, these exemplary embodiments allow the use of digital controller 202 for various platforms.

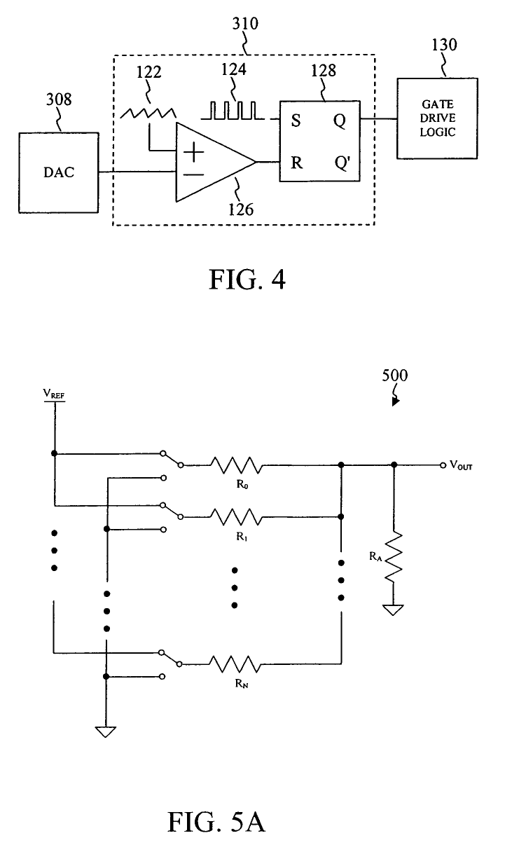

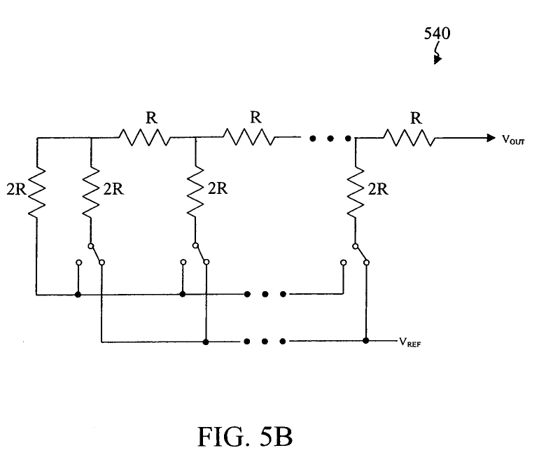

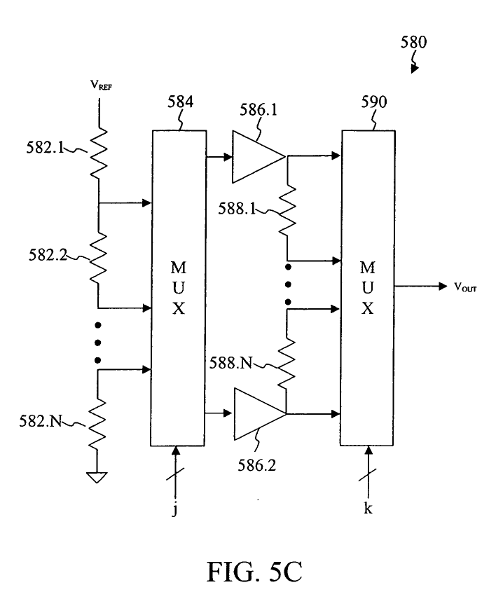

The mixed signal digital controller 302 next converts the digital duty cycle D_{C} generated by the control law module 314 to analog using a digital to analog converter (DAC) 308. Exemplary embodiments for the DAC 308 are shown in FIG. 5A through FIG. 5C. The mixed signal digital controller 302 next converts the output of the DAC 308 to a pulse width modulated signal using an analog pulse width modulator (APWM) 310. The APWM 310 is further described in FIG. 4.

A gate drive logic (GDL) module 316 drives a switch module 132 according to an output of the APWM 310. The switch module 132 may be implemented using metal oxide semiconductor field effect transistors (MOSFET) fabricated according to a complementary metal oxide semiconductor (CMOS) process. The switch module includes a switch 138 and a switch 140. The switch 138 and the switch 140 operate in a complementary manner. In other words, when the output of the APWM 310 is high, GDL module 316 closes the switch 138 while opening the switch 140. Opening of the switch 138 and closing of the switch 140 charges a capacitor 136 by allowing current to flow from the input voltage V_{IN} through the switch 138 and an inductor 134. By charging the capacitor 136, the mixed signal digital controller 302 increases the output voltage V_{OUT}. Likewise, when the output of the APWM 310 is low, GDL module 316 opens the switch 138 while closing the switch 140. Closing of the switch 140 and opening of the switch 138 discharges the capacitor 136 by allowing current to flow from the capacitor 136 through the switch 138 and the inductor 134 to ground. By discharging the capacitor 136, the mixed signal digital controller 302 decreases the output voltage V_{OUT}.

FIG. 4 illustrates a block diagram of mixed signal pulse width modulator according to an exemplary embodiment of the present invention. As shown in FIG. 4, the APWM 310 converts the output of the DAC 308 to a pulse width modulated signal. Unlike the DPWM module 208, the APWM 310 simplifies the PWM signal generation. This implementation can be used for current mode control too, where as the digital controller 202 cannot be easily adopted for current mode control. The APWM 310 may operate in the current mode if the ramp function is a sensed load (or switch) current and the output of DAC 308 is compared to a sense current ramp (or a combination of sense current and artificial ramp).

The APWM 310 includes a comparator 126 and a flip-flop 128. A comparator is a device that compares two voltages or currents and switches its output to indicate the larger of the two voltages or currents. The comparator 126 compares the output of the DAC 308 with a saw tooth or ramp function, denoted as 122 in FIG. 4. When the ramp function is lesser than the output of the error amplifier 104, the comparator 126 output is low and the Q output of the flip flop 128 stays high. Likewise, when the ramp function is greater than the output of the error amplifier 104, the comparator output goes high and resets the flip flop 128 output to low. Thus, the output of the comparator 126 forms a pulse whereby the relationship between the output of the DAC 308 and the ramp function determines the width of the pulse. In other words, the duty cycle of the output of the comparator 126 terminates when the ramp function crosses the output of the error amplifier 104. The flip-flop 128 then latches the output of the comparator 126 according to a clock pulse 124. In an exemplary embodiment, flip-flop 128 is implemented as a SR latch or SR-flip-flop, those skilled in the arts will recognize that any suitable device may be used. In this exemplary embodiment, the flip-flop 128 has a set and a reset input, denoted as S and R in FIG. 4 and two complementary outputs, denoted as Q and Q′. Normally, in storage mode, the S and the R input of flip-flop 128 are both low maintaining the Q and Q′ outputs in a constant state, with Q the complement of Q′. If the S (set) is pulsed high while the R (reset) is held low, then the Q output is forced high, and stays high when the S returns low. On the other hand, if the R is pulsed high while the S is held low, then the Q output is forced low, and stays low when the R returns low. The flip-flop 128 uses a clock pulse 124 for the set input and the output of the output of the comparator 126 for the reset input. As a result, the Q output of the flip-flop 128 represents a pulse width modulated (PWM) version of the clock pulse 124, where the pulse width is increased or decreased based on the output of the comparator 126.

Even though the functionality of the mixed signal controller was described for an exemplary synchronous voltage mode step down regulatory, the mixed controller can be used for step voltage regulation, non synchronous regulation by replacing switch 140 with a diode, or a current mode control. In the current mode control, the ramp function 122 is a combination of a fixed ramp and a sense current ramp. The sense current ramp is a fraction of the current through the switch 138 or the inductor 134.

FIG. 5A illustrates a block diagram of digital to analog converter (DAC) used in a mixed signal digital controller according to an exemplary embodiment of the present invention. DAC 500 is an exemplary embodiment of the DAC 308 as shown in FIG. 3. The DAC 500 converts a digital input V_{REF} into an analog output V_{OUT} using a binary weighted resistor divider. The binary weighted resistor divider is well known in the art.

In an exemplary embodiment, the series resistor R₀ through R_{N} contains four series resistors R₀ through R₃ configured with the ratio R₀: 2*R₀: 4*R₀: 8*R₀. In this exemplary embodiment, the series resistor R₀ corresponds to the least significant bit (LSB) of the digital input V_{REF} while the series resistor R₃ corresponds to the most significant bit (MSB) of the digital input V_{REF}.

FIG. 5B illustrates another block diagram of digital to analog converter (DAC) used in a mixed signal digital controller according to an exemplary embodiment of the present invention. DAC 540 is an exemplary embodiment of the DAC 308 as shown in FIG. 3. The DAC 540 converts a digital input V_{REF} into an analog output V_{OUT} using an R-2R resistor ladder. The R-2R resistor ladder is well known in the art.

In an exemplary embodiment, the series resistor contains three taps for a total of three series resistors denoted as R and four shunt resistors denoted as 2R. In this exemplary embodiment, the series resistor R closest to the analog output V_{OUT} corresponds to the least significant bit (LSB) of the digital input V_{REF} while the series resistor R furthest from the analog output V_{OUT} corresponds to the most significant bit (MSB) of the digital input V_{REF}.

FIG. 5C illustrates a further block diagram of digital to analog converter (DAC) used in a mixed signal digital controller according to an exemplary embodiment of the present invention. DAC 580 is an exemplary embodiment of the DAC 308 as shown in FIG. 3. The DAC 580 converts a digital input V_{REF} into an analog output V_{OUT} using a switched sub-divider resistor ladder.

The DAC 580 sub-divides the digital input V_{REF} using resistor 582. The resistor 582 comprises N series 582.1 through 582.N. The junction formed between the resistor 582 and an adjacent resistor 582 forms a tap. The voltage level of the digital input V_{REF} at a tap is less than the voltage level previous taps. In other words, the resistors 582.1 through 582.(N−1) from a series resistor of a voltage dividing network with the resistor 582.N shunted to ground. The DAC 580 uses each tap from resistor 582 as an input to a multiplexer 584. The multiplexer 584 selects a corresponding tap based upon a digital control word j. A buffer 586.1 uses a first output of the multiplexer 584 while a buffer uses a second output of the multiplexer 584. The buffer 586.1 and the buffer 586.2 isolate the multiplexer 584 from a multiplexer 590.

The DAC 580 uses the output of the buffer 586.1 and the output of the buffer 586.2 as an input to resistor 588. The output of the buffer 586.1 connects to resistor 588.1 while the output of the buffer 586.2 connects to resistor 588.N. The resistors 588.2 through 588.(N−1) are connected in series located in between the resistor 588.1 and the resistor 588.N. As with the resistor 582, the junction formed between the resistors 588 and an adjacent resistors 588 forms a tap. The DAC 580 uses each tap from resistor 588 as an input to a multiplexer 584. The multiplexer 590 selects a corresponding tap based upon a digital control word k to form the analog output V_{OUT}.

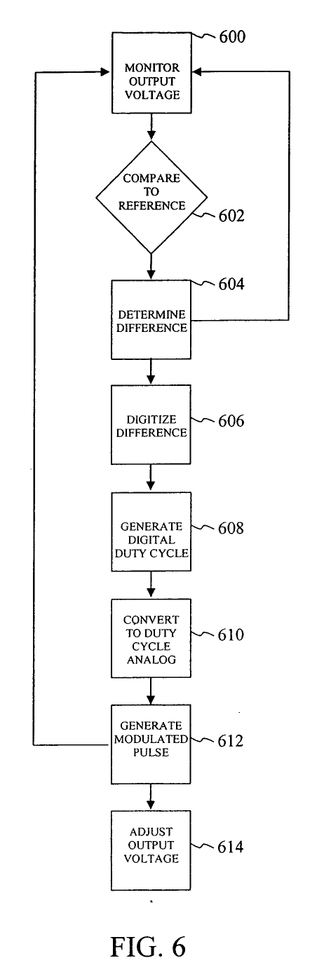

FIG. 6 is a flowchart of exemplary operational steps of a mixed signal digital controller according to an aspect of the present invention. The invention is not limited to this operational description. Rather, it will be apparent to persons skilled in the relevant art(s) from the teachings herein that other operational control flows are within the scope and spirit of the present invention. The following discussion describes the steps in FIG. 6.

At step 600, the output voltage of a switch-mode power supply is monitored or sensed.

At step 602, the output voltage is compared to a reference level. If the output voltage is substantially equivalent to the reference level, then the mixed signal digital controller returns to step 600, else the mixed signal digital controller proceeds to step 604.

At step 604, the difference between the output voltage and reference level is determined. The mixed signal digital controller may compare either the output voltage to a reference voltage level or a scaled version of the output voltage to a reference voltage level using an analog to digital converter (ADC).

At step 606, the difference of step 604 is digitized. The mixed signal digital controller may use an ADC such as the ADC 312 to digitize the difference between the output voltage and the reference level.

At step 608, a digital duty cycle for a pulse based upon the output of step 604 is generated. The mixed signal digital controller may generate the digital duty cycle using a control law module such as the control law module 314. The control law module implements a control function to regulate and stabilize the loop.

At step 610, the digital duty cycle is converted from digital to analog to generate an analog duty cycle. The mixed signal digital controller may use a DAC such as the DAC 308 to convert the digital duty cycle from digital to analog.

At step 612, a modulated pulse is generated using the output from step 610. The mixed signal digital controller may convert the analog output of the DAC to a pulse width modulated signal using an analog pulse width modulator such as the APWM 310. In other words, the pulse width of a pulse train is increased or decreased based upon the analog duty cycle.

At step 614, the output voltage is adjusted based upon the modulated pulse of step 612. The mixed signal digital controller may use a gate drive logic (GDL) module such as GDL 316 to drive a switch module according to the output of step 612. In other words, the mixed signal digital controller may regulate an input voltage to produce an output voltage based upon the output of step 612. The mixed signal digital controller reverts to step 600 to monitor the output voltage.

### CONCLUSION

While various embodiments of the present invention have been described above, it should be understood that they have been presented by way of example, and not limitation. It will be apparent to persons skilled in the relevant arts that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A mixed signal digital controller for a switch-mode power supply having an analog output comprising:
a digital portion to compare the analog output with a reference voltage and to output a digital duty cycle;
an analog portion coupled to the digital portion to convert the digital duty cycle to an analog pulse width modulated signal, wherein the analog output is based upon the analog pulse width modulated signal.

2. The mixed signal digital controller of claim 1, wherein the digital portion further comprises:
an analog to digital converter (ADC) to output a digital differential error signal generated by comparing the output voltage V_{OUT} and the reference voltage V_{REF}.

3. The mixed signal digital controller of claim 2, wherein the digital portion further comprises:
a control law module to compute the digital duty cycle based upon the digital differential error signal.

4. The mixed signal digital controller of claim 3, wherein a control function of the control law module is implemented using a proportional-integral-derivative (PID) control.

5. The mixed signal digital controller of claim 3, wherein a control function of the control law module is implemented according to:
D_{C}[k+1]=KₚDₑ[k]+K_{d}(Dₑ[k]−Dₑ[k−1])+KᵢDᵢ[k],
where D_{C}[k] represents a duty-ratio at discrete time k, Dₑ[k] represents a digitized version of the differential error signal, Dᵢ[k] represents a state of a digital integrator, given by Dᵢ[k+1]=Dᵢ[k]+Dₑ[k], Kₚ represents a proportional gain, K_{d} represents a derivative gain, and Kᵢ represents an integral gain.

6. The mixed signal digital controller of claim 1, wherein the analog portion further comprises:
a digital to analog converter (DAC) to convert the digital duty cycle from digital to analog.

7. The mixed signal digital controller of claim 6, wherein the analog portion further comprises:
an analog pulse width modulator (APWM) coupled to the DAC to convert an output of the DAC to the pulse width modulated signal.

8. The mixed signal digital controller of claim 7, wherein the APWM further comprises:
a comparator to compare the output of the DAC with a ramp function to output a pulse width; and
a flip-flop coupled to the comparator to generate the pulse width modulated signal based upon the pulse width.

9. The mixed signal digital controller of claim 7, wherein the analog portion further comprises:
a gate drive logic module to drive a switch module according to the pulse width modulated signal, wherein the switch module regulates an analog input to generate the analog output based upon the pulse width modulated signal.

10. A method to control an output voltage for a switch-mode power supply comprising:
monitoring the output voltage;
comparing the output voltage to a reference level;
determining a difference between the output voltage and the reference level;
converting the difference between the output voltage and the reference level to a digital signal;
calculating a digital duty cycle for a pulse based upon the digital signal;
converting the digital duty cycle to an analog duty-ratio;
modulating the analog duty-ratio using a pulse width modulation scheme to generate a pulse width modulated signal; and
adjusting the output voltage based upon the pulse modulated signal.

11. The method of step 10, wherein the step of determining a difference of between the output voltage and the reference level comprises:
scaling the output voltage;

12. The method of step 10, wherein an analog to digital converter (ADC) converts the difference between the output voltage and the reference level to a digital signal.

13. The method of step 10, wherein a digital to analog converter (DAC) converts the digital duty cycle to an analog signal.

14. The method of step 10, wherein the step of calculating a digital duty cycle for a pulse based upon the digital signal further comprises:
using a control function to generate the digital duty cycle.

15. The method of step 10, wherein the step of modulating the analog duty-ratio using a pulse width modulation scheme further comprises:
comparing the analog duty-ratio with a ramp function to generate a duty cycle.

16. The method of step 10, wherein a gate drive logic (GDL) module is used to adjust the output voltage based upon the pulse modulated signal.

17. A mixed signal digital controller for a switch-mode power supply having an analog output comprising:
an analog to digital converter (ADC) configured to receive the analog output and a reference voltage;
a control law module coupled to the ADC;
a digital to analog converter (DAC) coupled to the control law module;
an analog pulse width modulator (APWM) coupled to the DAC; and
a gate drive logic (GDL) coupled to the APWM.

18. The mixed signal digital controller of claim 17, wherein the APWM further comprises:
a comparator coupled to the DAC configured to receive a ramp function; and
a flip-flop coupled to the comparator configured to receive a clock pulse.
